(19) United States
(12) Patent Application Publication
(10) Pub. No.: US 2006/0007556 A1
(43) Pub. Date: Jan. 12, 2006

(54) Projector optical device

(76) Inventors: Taketoshi Okajima, Saitama-shi (JP); Takashi Itohiya, Saitama-shi (JP)

Correspondence Address: JACOBSON HOLMAN PLLC, 400 SEVENTH STREET N.W., SUITE 600, WASHINGTON, DC, 20004, US

(21) Appl. No.: 11/168,879

(22) Filed: Jun. 29, 2005

(30) Foreign Application Priority Data
Jun. 30, 2004 (JP) 2004-194005
Jun. 28, 2005 (JP) 2005-188652

(51) Int. Cl. G02B 3/00

(52) U.S. Cl. 359/649

(57) ABSTRACT

An object of the present invention is to provide a projector optical device in which both of an image forming section and a screen are held stationary in their fixed locations and an object image distance is constant, wherein an effect from a variation of optical characteristics caused by the heat, such as a variation of focal distance of a lens in a projection lens system located in the vicinity of a light source, can be eliminated and thereby a clear image in the initial focused condition can be maintained on the screen. Provided is A projector optical device including a retro-focus projection lens system characterized in that at least one or more lenses of a group of convex lenses in said retro-focus projection lens system located in an light source side is supported by a compensation member capable of expanding or contracting in the direction of an optical axis in response to a temperature change, wherein an object image distance being variated by a variation of a focal distance of said group of convex lenses caused by a temperature change is compensated for by difference of the expansion or the contraction of said compensation members resultant from the temperature change.

### FIELD OF THE INVENTION

The present invention relates to a projector optical device having a fear that a lens system could be subject to a temperature change, including, for example, a rear projection-type imaging unit, such as a rear projection television and a rear projector, and a front projector to be used in a home theater environment, all of which have a lens system and an exothermic light source. In particular, the present invention relates to a projector optical device which allows a predetermined clear image to be formed continuously even if the lens system is subject to a temperature change and thereby causes a variation of its optical performance, by compensating for said variation.

### DESCRIPTION OF THE PRIOR ART

In both of the rear projector and the front projector, considering from the optical viewpoint, once they have been provided with a focus adjustment, an “object image distance” defined by an optical distance between an image forming section, such as a liquid crystal, and a screen disposed in an image-forming site is kept to be constant. On one hand, such projector includes as a light source a Xenon lamp or the like generally exhibiting high heating value. A heat radiation from this light source have much effect of high temperature especially on a lens located in the vicinity of the light source of the projection optical system.

On the other hand, recently, in order to project the optically excellent video images that are free from any types of aberration, an anomalous dispersion glass lens and/or a plastic lens have been employed in the projection optical system. The variation of the optical performance of the anomalous dispersion glass lens caused by the temperature change is shown in Table 2 by taking the reference values designed at a reference temperature of 20° C., which will be described later, and it has been made obvious that the optical performance is deteriorated by the temperature change.

Conventionally, a temperature compensated optical device has been suggested, in which a focal distance variation of the lens resultant from the temperature rise can be compensated for (see for example, the Patent Document No. 1). That is, in this optical device (i.e., a coliimator) composed of a lens barrel whose length would be changed in association with the temperature change and a lens held in this lens barrel, the lens is made of such a material that allows the focal distance to be changed in response to the temperature change but the change in the focal distance is offset by the change in the barrel length of the lens barrel, so that the focusing position of the lens can be held constantly in a certain position. With this configuration in the optical device composed of the lens barrel and the lens, such a temperature compensated optical device can be obtained that can prevent a fluctuation of the focusing position as of the optical device even if the length of the lens barrel has been changed due to the temperature change.

Further, such a camera has been conventionally suggested, in which the variation of the focusing position of a camera lens due to the temperature change can be mechanically offset and compensated for by using a material having a degree of freedom in selection (see, for example, Patent Document No. 2). That is, provided is a camera comprising: a lens frame for holding a camera lens system including a plastic lens; a lens barrel for fixing the lens frame onto a lens frame fixing portion; an elastic member disposed substantially in parallel with the lens barrel frame and fixed to an immobilized fixing member in a site located in an image-forming plane side defined by the camera lens; and a connecting member disposed substantially in parallel with the elastic member and connected to the lens barrel in a site located in the image-forming plane side with respect to the lens frame fixing portion and to the telescopic member in a site located in the object side with respect to the fixing portion to the fixing member, respectively, so as to support the lens barrel, wherein both of the lens barrel and the elastic member are made of material having a large coefficient of linear expansion, while the lens frame and the connecting member are made of material having a small coefficient of linear expansion.

[Patent Document No. 1] Japanese Patent Laid-open Publication No. Hei6-130267

[Patent Document No. 2] Japanese Patent Laid-open Publication No. 2003-185904

The optical devices as disclosed in the Patent Documents Nos. 1 and 2 are designed to compensate for the variation of the focal distance of the entire projection lens system. Accordingly, it is true that the technologies disclosed in the above Patent Documents are effective to compensate for the variation of the focusing position, but since the focal distance of the projection lens system has varied and thereby the location of image-forming has been also shifted, therefore the clear image achievable in the initial focused condition could not be obtained unless the screen position is correctly shifted.

On one hand, in the projector optical device described above, after the focusing adjustment having been performed at an initial stage, typically the image forming section and the screen are held stationary in their fixed locations, and accordingly the clear image achievable in the initial focused condition could not be maintained on the screen. That is, for example, in case where the focal distance of the projection lens system has become longer due to the temperature rise, even if the distance between the projection optical system and the image-forming section is adjusted to be longer such that the focusing position may be placed in a proper location, in contrast with an expectation that the space between the projection lens system and the screen should become longer in response to the increase in the focal distance of the projection lens system, actually said space between the projection lens system and the screen is made shorter by a distance equivalent to the displacement of the projection lens toward the screen side, and accordingly the clear image achievable in the initial focused condition could not be maintained on the screen.

### SUMMARY OF THE INVENTION

The present invention has been made in the light of the above-pointed problems in association with the projector optical devices according to the prior art, and an object thereof is to provide a projector optical device in which both of an image forming section and a screen are held stationary in the object image distance is constant, wherein an effect from a variation of optical characteristics caused by the heat, such as a variation of the focal distance of a lens in a projection lens system located in the vicinity of a light source, can be eliminated and thereby a clear image in the initial focused condition can be maintained on the screen.

The present invention provides a projector optical device including a retro-focus projection lens system characterized in that at least one or more lenses of a group of convex lenses in said retro-focus projection lens system, located in an light source side, is supported by a compensation member capable of expanding or contracting in the direction of an optical axis in response to a temperature change, wherein an object image distance being variated by a variation of a focal distance of said group of convex lenses caused by a temperature change is compensated for by difference of the expansion or the contraction of said compensation members resultant from the temperature change.

Preferred embodiments of the present invention will be described below.

An embodiment of the present invention is characterized in that said group of convex lenses includes an anomalous dispersion glass lens.

An alternative embodiment of the present invention is characterized in that said group of convex lenses includes a plastic lens.

An another alternative embodiment of the present invention is characterized in that said projector optical device is a front projector.

An another alternative embodiment of the present invention is characterized in that said projector optical device is a rear projector. An another alternative embodiment of the present invention is characterized in that said compensation members comprise
a first elastic lens barrel fixed to a fixing lens barrel which is fixed to the projector optical device and extending toward the light source side, and
a second elastic lens barrel fixed to said elastic first lens barrel at the light source side concerning a fixed position of said elastic first lens barrel to said fixing lens barrel, extending toward a screen and supporting at least a part of a group of convex lenses in said retro-focus projection lens system at its front portion, wherein a coefficient of linear expansion of said second elastic lens barrel is larger than one of said first elastic lens barrel.

An another alternative embodiment of the present invention is characterized in that said first elastic lens barrel has substantially the same length as said second elastic lens barrel in the direction of optical axis.

An another alternative embodiment of the present invention is characterized in that a micro-display is supported at a rear portion of a fixing lens barrel extending toward the light source.

### FUNCTIONAL ADVANTAGES OF THE INVENTION

According to a projector optical device of the present invention, such an effect can be obtained that in the projector optical device in which both of the image forming section and the screen are held stationary in their fixed locations and the object image distance is constant, the effect from the variation of the optical characteristics caused by the heat, such as the variation of the focal distance of the lens in the projection lens system located in the vicinity of the light source, can be eliminated and thereby the clear image in the initial focused condition can be maintained on the screen.

Namely, according to a projector optical device of the present invention, it is assumed that temperature in an area around the retro-focus projection lens becomes higher under the condition which the clear image in the focused condition is maintained on the screen. Back focal distance BF of the retro-focus projecting lens is lengthen and then an image projected from the projection lens is made over the screen, namely at the area of the screen opposite to the area thereof facing toward the projection optical device. Meanwhile the at least one or more lenses of a group of convex lenses in the retro-focus projection lens system located in the light source side is moved toward the screen in accordance with the difference of the expansion or the contraction of said compensation members resultant from the temperature change. As a result the object image distance is shortened and the clear image in the initial focused condition is realized on the screen again.

Further, according to a projector optical device of the present invention, even if the at least one or more lenses of a group of convex lenses in the retro-focus projection lens system, located in the light source side, is located at a position where a lens barrel supports it, in the condition that the first lens barrel has substantially the same length as that of the second lens barrel in the direction of the optical axis, it is possible to move the at least one or more lenses of a group of convex lenses in the retro-focus projection lens system toward the screen by the predetermined distance on the basis of difference of elongations between the first elastic lens barrel and the second elastic lens barrels. As a result the harmful effects of elongation of the back focal distance BF caused by heating is removed, namely the object image distance is shortened and the clear image in the initial focused condition is realized on the screen again.

### BRIEF DESCRIPTION OF THE DRAWINGS

FIG. 1 is a sectional view of an optical system and relating components in a projector optical device according to an embodiment of the present invention.

### DETAILED DESCRIPTION OF THE PREFERRED EMBODIMENTS

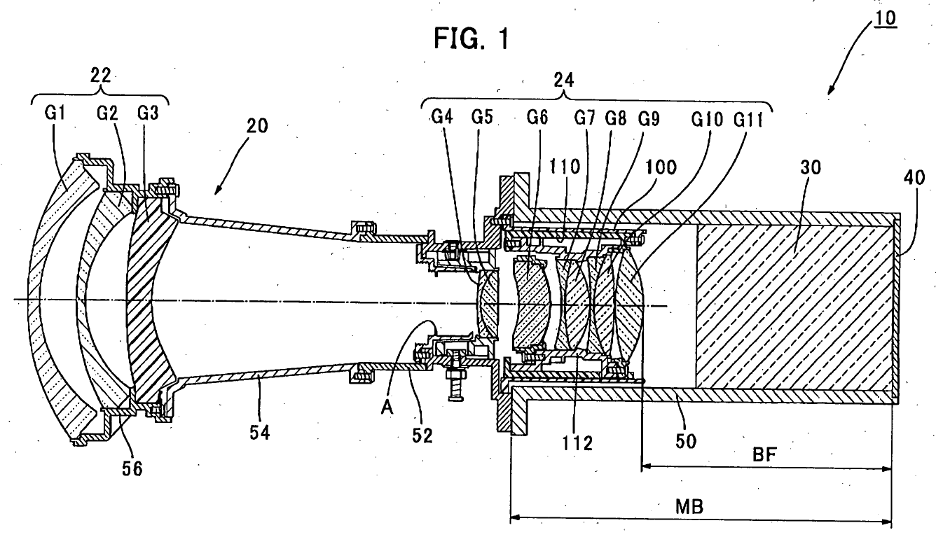

A projector optical device according to an embodiment of the present invention will now be described with reference to the attached drawings. The projector optical device 10 comprises a projection lens system 20 of retro-focus type specified by a focal distance of 8.8 mm, a prism system 30 and a micro-display 40 serving as an image-forming section, as shown in FIG. 1. A light source (not shown in FIG. 1) is located behind the micro-display 40. Magnification of projection is 79 to 106. The projection lens system 20 comprises a group of front lenses 22 consisting of lenses G1 to G3 and specified by the focal distance of −27.6 mm and a group of rear lenses 24 consisting of lenses G4 to G11 and specified by the focal distance of +43.26 mm. The lens G3 is a plastic lens. The lenses G8, G10 and G11 are anomalous dispersion glass lenses. A screen (not shown in FIG. 1) is located in front of the group of front lens 22.

The above-described optical components are supported by a first lens barrel 50, a second lens barrel 52, a third lens barrel 54 and a fourth lens barrel 56. The first lens barrel 50 supported by a projector optical device main body (not shown) supports the second lens barrel 52 as well as a first elastic lens barrel 100. The first lens barrel 50 also supports the micro-display 40 at its rear portion. The second lens barrel 52 supports the third lens barrel 54 as well as the lenses G4 and G5 and an aperture A. The third lens barrel 54 supports the fourth lens barrel 56. The fourth lens barrel 56 supports the lenses G1 to G3.

The first elastic lens barrel 100 supported in its front end portion by a screen side end portion or an front end portion of the first lens barrel 50 supports in its rear end portion a rear end portion of a second elastic lens barrel 110. The second elastic lens barrel 110, in turn, supports in its front end portion the lenses G6 to G11 via a lens frame 112. The focal distance formed by the lenses G6 to G11 is −80.65 mm. The first elastic lens barrel 100 and the second elastic lens barrel 110 operate as compensation members for compensating for a displacement along an optical axis and a change in the focal distance of said group of convex lenses caused by the temperature change.

The first lens barrel 50, the second lens barrel 52, the third lens barrel 54 and the fourth lens barrel 56 are made of brass, aluminum and the like. The first elastic lens barrel 100 is made of PPS having a coefficient of linear expansion of 18×10⁻⁶. The second elastic lens barrel 110 is made of PC having a coefficient of linear expansion of 7×10⁻⁶.

In an alternative embodiment, the first elastic lens barrel 100 may be made of PC-G30% having a coefficient of linear expansion of 30×10⁻⁶. The second elastic lens barrel 110 may be made of ABS having a coefficient of linear expansion of 12×10⁻⁵.

Calculated values of the compensation for the temperature change in the above projector optical device 10 are as indicated in Table 1. In Table 1, an amount of out-of-focus indicates a difference in position of an image-forming position relative to a screen position. The coefficient of linear expansion of the brass used in the first lens barrel 50 is 18×10⁻⁶ and the coefficient of linear expansion for the aluminum is 23.6×10⁻⁶. “First lens barrel expansion ignored” in Table 1 indicates that the First lens barrel 50 is made from ceramics and the like.

TABLE 1

| | | Amount of | | | | | |
|---|---|---|---|---|---|---|---|
| | | out-of-focus | | First lens barrel made | | First lens barrel made | |
| Temp. in the front side | Temp. in the rear side | (First lens barrel | | of brass | | of aluminus | |
| of the aperture | of the aperture | expansion ignored) | | Amount of out-of-focus | | Amount of out-of-focus | |
| 20° C. | 20° C. | 0.0 | μm | 0.0 | μm | 0.0 | μm |
| 0° C. | 0° C. | −78.3 | μm | −34.4 | μm | −20.7 | μm |
| 40° C. | 40° C. | 80.5 | μm | 36.6 | μm | 22.9 | μm |
| 50° C. | 50° C. | 120.8 | μm | 54.9 | μm | 34.4 | μm |
| 60° C. | 60° C. | 163.0 | μm | 75.2 | μm | 47.8 | μm |
| 40° C. | 50° C. | 126.7 | μm | 60.8 | μm | 40.3 | μm |
| 40° C. | 60° C. | 174.7 | μm | 86.9 | μm | 59.5 | μm |
| 50° C. | 60° C. | 168.8 | μm | 81.0 | μm | 53.6 | μm |

Further, in a prototype of the above-described projector optical device 10 shown in FIG. 1, a distance FD between an article mounting surface (flange surface) and a rear end surface of lenses and a metal-backed value MB and a flange-backed value FB relative to a reference taken at 20° C. were the distance FD of 47.452 mm (deviation by −0.022 mm) and the MB of 123.602 mm (deviation by −0.030 mm), respectively, at 0° C. The distance FD of 47.542 mm (deviation. by +0.068 mm) and the FB of 123.691 mm (deviation by +0.059 mm) were observed at 50° C.

In the above mentioned embodiment the first lens barrel 50 is made of brass or aluminum which have a small coefficient of linear expansion. It is known from Tables 1 and 2 relating to the above mentioned structure that the micro-display 40 is moved rearwardly to a certain extent. The object image distance is slightly shortened by such a first lens barrel 50 so that the amount of out-of-focus is slightly decreased. As a result the harmful effects of elongation of the back focal distance BF caused by heating has been removed to a certain extent.

It can be easily estimated by one in the person skilled in the art that, if the first lens barrel 50 is made of PC having a coefficient of linear expansion of 7×10⁻⁵ or ABS having a coefficient of linear expansion of 12×10⁻⁵, the micro-display 40 is sufficiently moved rearwardly. The object image distance is appropriately shortened by such a first lens barrel 50 so that the amount of out-of-focus is thoroughly decreased. As a result the harmful effects of elongation of the back focal distance BF caused by heating has been effectively removed.

### COMPARATIVE EXAMPLE

In the comparative example the first elastic lens barrel and the second elastic lens barrel are not used and the lens barrel 112 supporting the lenses G6˜G11 is directly mounted on the second lens barrel 52. “First lens barrel expansion ignored” in Table 2 indicates that the First lens barrel is made from ceramics and the like.

TABLE 2

| | | Amount of out-of- | | First lens barrel made | | First lens barrel made | |
|---|---|---|---|---|---|---|---|
| | | focus | | of brass | | of aluminums | |
| Temp. in the front | Temp. in the rear side | (First lens barrel | | Amount of out-of- | | Amount of out-of- | |
| said of the aperture | of the aperture | expansion ignored) | | focus | | focus | |
| 20° C. | 20° C. | 0.0 | μm | 0.0 | μm | 0.0 | μm |
| 0° C. | 0° C. | −120.0 | μm | −76.1 | μm | −62.4 | μm |
| 40° C. | 40° C. | 122.2 | μm | 78.3 | μm | 64.6 | μm |
| 50° C. | 50° C. | 184.0 | μm | 118.1 | μm | 97.6 | μm |
| 60° C. | 60° C. | 247.4 | μm | 159.6 | μm | 132.2 | μm |
| 40° C. | 50° C. | 189.9 | μm | 124.0 | μm | 103.5 | μm |
| 40° C. | 60° C. | 259.2 | μm | 171.4 | μm | 144.0 | μm |
| 50° C. | 60° C. | 253.3 | μm | 165.5 | μm | 138.1 | μm |

### INDUSTRIAL APPLICABILITY

Although the present invention has been described with reference to the embodiment representing the projection lens system of retro-focus type, the technological concept thereof can be embodied effectively even in the lens system of other types, including, for example, the lens system of Gauss-type or Petzval-type.

What is claimed is:

1. A projector optical device including a retro-focus projection lens system characterized in that at least one or more lenses of a group of convex lenses in said retro-focus projection lens system located in an light source side is supported by a compensation member capable of expanding or contracting in the direction of an optical axis in response to a temperature change, wherein an object image distance being variated by a variation of a focal distance of said group of convex lenses caused by a temperature change is compensated for by difference of the expansion or the contraction of said compensation members resultant from the temperature change.

2. A projector optical device in accordance with claim 1, in which said group of convex lenses includes an anomalous dispersion glass lens.

3. A projector optical device in accordance with claim 1, in which said group of convex lenses includes a plastic lens.

4. A projector optical device in accordance with claim 1, in which said projector optical device is a front projector.

5. A projector optical device in accordance with claim 1, in which said projector optical device is a rear projector.

6. A projector optical device in accordance with claim 1, in which said compensation members comprise
a first elastic lens barrel fixed to a fixing lens barrel which is fixed to the projector optical device and extending toward the light source side, and
a second elastic lens barrel fixed to said elastic first lens barrel at the light source side concerning a fixed position of said elastic first lens barrel to said fixing lens barrel, extending toward a screen and supporting at least a part of a group of convex lenses in said retro-focus projection lens system at its front portion, wherein a coefficient of linear expansion of said second elastic lens barrel is larger than one of said first elastic lens barrel.

7. A projector optical device in accordance with claim 6, in which said first elastic lens barrel has substantially the same length as said second elastic lens barrel in the direction of optical axis.

8. A projector optical device in accordance with claim 1, in which a micro-display is supported at a rear portion of a fixing lens barrel extending toward the light source.
